(19) United States
(12) Patent Application Publication
(10) Pub. No.: US 2006/0205368 A1
(43) Pub. Date: Sep. 14, 2006

(54) Selecting an optimal antenna according to an operating state of a device

(75) Inventors: Sergio Bustamante, Pembroke Pines, FL (US); Raziuddin Ali, Weston, FL (US); Brian E. Bucknor, Miramar, FL (US); Jose M. Gonzalez, Pembroke Pines, FL (US); Tal Mor, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/079,415

(22) Filed: Mar. 14, 2005

(51) Int. Cl. H04B 1/02; H04M 1/00; H04B 1/06

(52) U.S. Cl. 455/101; 455/575.7; 455/272

(57) ABSTRACT

A device (100) has a housing assembly having a plurality of housing portions which can shift relative to each other, a plurality of antennas (102) distributed among the plurality of housing portions, a receiver (104A) coupled to the plurality of antennas for receiving signals carrying information from a source, and a processor (106) coupled to the receiver. The processor is programmed to sense (202) one or more operating states of the device, and identify (204) from the one or more operating states an antenna from the plurality of antennas having a probability higher than the other antennas for successfully receiving information from the source.

### FIELD OF THE INVENTION

This invention relates generally to devices applying antenna diversity techniques, and more particularly to selecting an optimal antenna according to an operating state of a device.

### BACKGROUND OF THE INVENTION

Depending on orientation, devices with a single antenna receiver frequently fall short of providing adequate signal reception.

### SUMMARY OF THE INVENTION

Embodiments in accordance with the invention provide an apparatus and method for selecting an optimal antenna according to an operating state of a device.

In a first embodiment of the present invention, a device has a housing assembly having a plurality of housing portions which can shift relative to each other, a plurality of antennas distributed among the plurality of housing portions, a receiver coupled to the plurality of antennas for receiving signals carrying information from a source, and a processor coupled to the receiver. The processor is programmed to sense one or more operating states of the device, and identify from the one or more operating states an antenna from the plurality of antennas having a probability higher than the other antennas for successfully receiving information from the source.

In a second embodiment of the present invention, a selective call radio (SCR) has a housing assembly having a plurality of housing portions which can shift relative to each other, a plurality of antennas distributed among the plurality of housing portions, a transceiver coupled to the plurality of antennas for transmitting and receiving signals carrying information to and from a communication network, and a processor coupled to the transceiver. The processor is programmed to sense one or more operating states of the SCR, when a need arises to transmit signals to the communication network, identify from the one or more operating states an antenna from the plurality of antennas having a probability higher than the other antennas for successfully transmitting signals carrying information to the communication network, and when a need arises to receive signals from the communication network, identify from the one or more operating states an antenna from the plurality of antennas having a probability higher than the other antennas for successfully receiving information from the communication network.

In a third embodiment of the present invention, a method in a selective call radio (SCR) is provided. The SCR has a housing assembly having a plurality of housing portions which can shift relative to each other, a plurality of antennas distributed among the plurality of housing portions, and a transceiver coupled to the plurality of antennas for transmitting and receiving signals carrying information to and from a source. The method includes the steps of sensing one or more operating states of the SCR, when a need arises to transmit signals to the source, identifying from the one or more operating states an antenna from the plurality of antennas having a probability higher than the other antennas for successfully transmitting signals carrying information to the source, and when a need arises to receive signals from the source, identifying from the one or more operating states an antenna from the plurality of antennas having a probability higher than the other antennas for successfully receiving information from the source.

### BRIEF DESCRIPTION OF THE DRAWINGS

FIG. 1 is a block diagram of a device embodied in a selective call radio (SCR) in accordance with an embodiment of the present invention;

FIG. 2 is a flow chart depicting a method operating in the SCR in accordance with an embodiment of the present invention; and

FIGS. 3-4 are portions of a housing assembly of the SCR in open and closed positions, respectively, in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

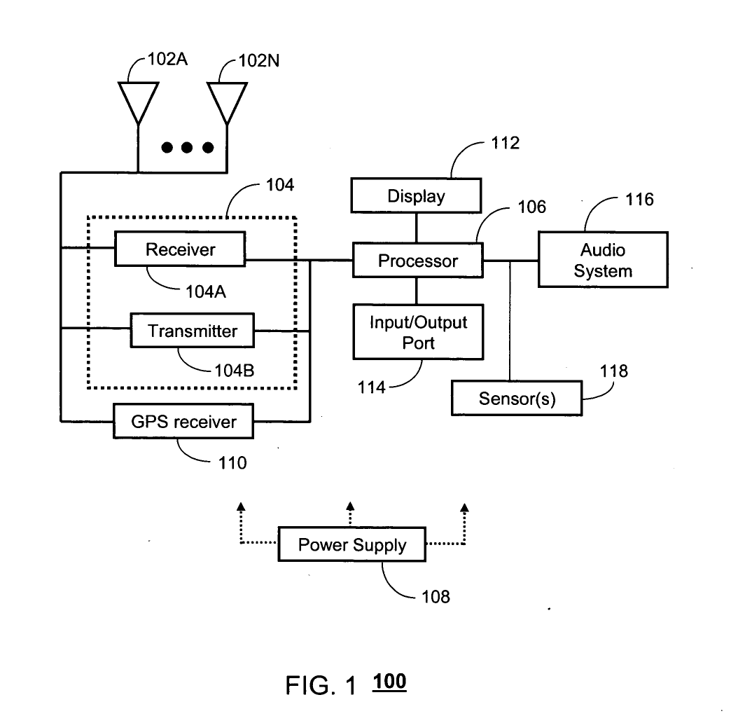

FIG. 1 is a block diagram of a device embodied in a selective call radio (SCR) 100 in accordance with an embodiment of the present invention. In its simplest embodiment, the SCR 100 has conventional technology comprising a plurality of antennas 102A-102N, a receiver 104A, a processor 106 and a conventional power supply 108 for supplying power to the components of the SCR 100. The plurality of antennas 102A-102N are coupled to the receiver 104A utilizing conventional switching technology for selectively choosing one of the antennas 102 during operation. The receiver 104A is capable of receiving voice and/or data signals from the selected antenna 102 from a source such as a conventional communication network (e.g., a cellular network or another mobile communications unit). These messages are processed by the receiver 104A utilizing conventional demodulation techniques. The processor 106 includes a conventional memory, and a microprocessor and/or a DSP (Digital Signal Processor), each operating with one or more conventional clocks for processing signals from the receiver 104A.

In a second embodiment of the present invention, the SCR 100 further includes a transmitter 104B coupled to the antennas 102A-102N utilizing switching technology in a similar manner as described above for transmitting voice and/or data signals on the selected antenna 102 utilizing conventional modulation techniques. These signals are then intercepted by the communication network, which in turn relays said signals to, for example, another SCR 100. The combination of the receiver 104A and transmitter 104B portions provides the function of a transceiver 104. In yet another embodiment, the SCR 100 can further include conventional components such as a Global Positioning System (GPS) receiver 110, a display 112, an input and output port 114, an audio system 116, and one or more sensors 118.

In this latter embodiment, the GPS receiver 110 is also coupled to the antennas 102A-102N utilizing similar switching technology as described above and can be managed by the processor 106 to determine the location of the SCR 100 according to signals received by the selected antenna 102 corresponding to four or more GPS satellites detected from a constellation of twenty-four GPS satellites roaming around the Earth. The display 112 can be used by the processor 106 for presenting a UI (User Interface) for manipulating functions of the SCR 100 and for presenting other valuable information to an end user of the SCR 100 such as a map with a location of the SCR 100. The input and output port 114 can be used to receive signals from, for example, a conventional keypad with navigation capability coupled thereto. The input and output port 114 can also be used for coupling to external accessories that further enhance the functions of the SCR 100.

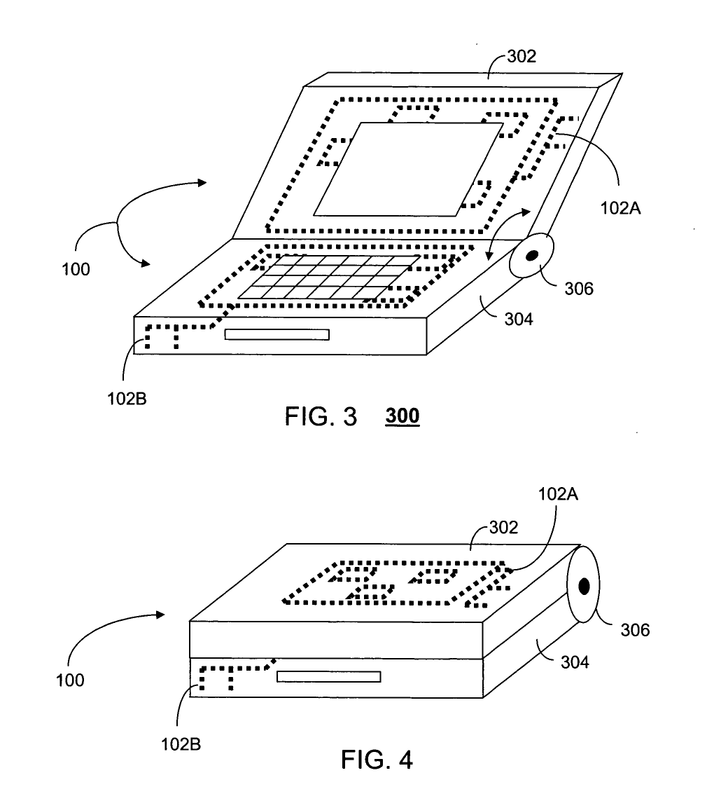

The audio system 116 can be used by the processor 106 for many functions such as voice processing, speakerphone (where the SCR 100 is, for example, a cell phone), music delivery to an end user of the SCR 100, and presenting multimedia audible signals, just to name a few. The foregoing components 102-116 of the SCR 100 are carried by a conventional housing assembly having a plurality of housing portions 302-306 (see FIGS. 3-4 as an illustration with two antennas 102A-102B carried by housing portions 302 and 304, respectively), which can shift relative to each other. The one or more sensors 118 (herein referred to as “sensor” or “sensors”) also carried by the housing assembly can be used by the processor 106 to track a change in the relative position of the housing portions of the SCR 100.

For example, in an embodiment where the SCR 100 is a cell phone, a first housing portion can be a flip assembly carrying the display 112 and a headset speaker coupled to the audio system 116 for listening to voice messages. A second housing portion can be a base assembly coupled to the flip assembly by way of a conventional hinge. The base assembly can carry, for example, a conventional keypad, a microphone coupled to the audio system 116 for receiving audio signals from an end user of the SCR 100, and a port coupled to the input and output port 114 for coupling with accessories of the SCR 100. In this illustration, the sensors 118 can be used by the processor 106 to detect the relative position of the flip to the base assembly (e.g., open flip and closed flip).

The sensors 118 can further include conventional technology to sense relative proximity of the SCR 100 to the human body of the end user of the SCR 100 or to other relevant obstructions that might have an effect on the performance of the antennas 102A-102N. The sensors 118 can also include conventional technology to sense the relative position of the assemblies according to a perspective of the SCR 100 (e.g., flip in a vertical up or downward position, flip in a horizontal up or downward position). Any conventional sensing device that can determine the relative position of the housing portions of the SCR 100 can be incorporated in the sensors 118.

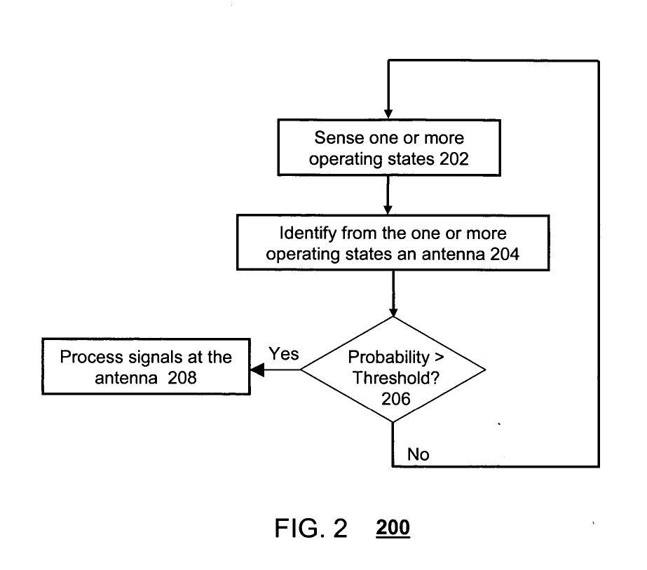

FIG. 2 is a flow chart depicting a method 200 operating in the device embodied by the SCR 100 in accordance with an embodiment of the present invention. The method 200 begins with step 202 where the processor 106 is programmed to sense one or more operating states of the SCR 100. In step 204, the processor 106 identifies from the one or more operating states an antenna 102 from the plurality of antennas 102A-102N having a probability higher than the other antennas 102 for successfully receiving from the receiver 104A information from a source (represented in this illustration by the communication network referred to above). Alternatively, in step 204, the processor 106 identifies from the one or more operating states an antenna 102 from the plurality of antennas 102A-102N having a probability higher than the other antennas 102 for successfully receiving from the GPS receiver 110 information from the GPS satellites. In yet another embodiment, step 204 can also identify from the one or more operating states an antenna 102 from the plurality of antennas 102A-102N having a probability higher than the other antennas for successfully transmitting information from the transmitter 104B to the communication network.

In a supplemental embodiment, the processor 106 proceeds to step 206 to process signals in step 208 with the antenna 102 selected in step 204 if the probability for receiving from the receiver 104A (or GPS receiver 110) information from the communication network (or the GPS satellites) is greater than a predetermined threshold. Similarly, the processor 106 proceeds to step 206 to process signals in step 208 with the antenna 102 selected in step 204 if the probability for transmitting from the transmitter 104B information to the communication network is greater than the predetermined threshold. If in any of the foregoing embodiments the probability falls below the predetermined threshold, then the processor 106 proceeds to step 202 to repeat the foregoing steps of the method 200. The statistics gathered in a predetermined manner (such as in a laboratory) or in real time can be compared to a predetermined threshold to improve the antenna selection process. This predetermined threshold can be programmed by the end user of the SCR 100 by way of the user interface, pre-programmed in the SCR 100 prior to distribution to an end user, or combinations thereof.

There are many operating states the processor 106 can sense in step 202 to identify an antenna 102 in step 204 having the highest probability for transmitting or receiving information to and from the communication network (or GPS satellites). Each of these operating states can be analyzed, for example, in a laboratory to determine the relative performance of each antenna 102A-102N under such conditions. The results of said analysis can then be pre-stored in the memory of the processor 106 for implementing the method 200. Alternatively, the processor 106 can perform the foregoing analysis during normal operations. In this instance, the processor 106 can be programmed to monitor the relative performance of each antenna 102 under varying operating states.

What follows are examples of operating states of an SCR 100. For illustration purposes only, these examples assume an SCR 100 having two antennas 102A-102B. It is further assumed that the SCR 100 has a housing assembly comprising a flip assembly 302 and a base assembly 304 coupled to each other by way of a conventional hinge 306, each of the assemblies carrying a portion of the components 102-118 of the SCR 100. The flip assembly 302 can carry, for example, the first antenna 102A away from the hinge 306. The flip assembly further holds the display 112, and a conventional headset speaker near the tip of the flip coupled to the audio system 116 for listening to voice messages.

Portions of the base assembly 304 have distributed among them the processor 106, a conventional keypad coupled to the input port 114, a microphone coupled to the electrical components of the audio system 116 for receiving audio signals from an end user of the SCR 100, a speaker coupled to the rear portion of the base assembly for presenting audio messages as a speakerphone feature, a headset connector near the hinge coupled to the input port 114 and the audio system 116 for accepting a tethered portable headset accessory for hands-free communications, and a battery coupled to the electrical components of the power supply 108. The base assembly 304 further includes the second antenna 102B. The second antenna 102B can be an antenna having a stem coupled to a conventional PCB (Printed Circuit Board) carrying a portion of said components of the SCR 100.

Each of these antennas 102A-102B is electrically coupled to the transceiver 104 and GPS receiver 110 utilizing conventional switching components as described above. Furthermore the sensors 118 can be distributed among the flip and base assemblies to detect the relative position of each housing portion (e.g., open flip, closed flip, flip near a body, flip in vertical upward or downward position, flip in horizontal upward or downward position, etc.).

The following are a few examples of operating states of an SCR 100 that the processor 106 can monitor and act upon to select one of the antennas 102A-102B located in the flip and base assemblies, respectively.
1. Active communications taking place between the SCR 100 and the communication network. In this example, the end user of the SCR 100 has instructed the processor 106 by way of the UI his or her intention to process voice messages by way of the headset speaker on the flip assembly. It is therefore assumed the end user places the flip assembly near in an open position (as shown in FIG. 3) his or her ear to listen to audio signals processed by the audio system 116.
2. Active communications taking place between the SCR 100 and the communication network. In this example, the end user of the SCR 100 has instructed the processor 106 by way of the UI his or her intention to process voice messages as audio signals played through the audio system 116 located in base assembly. In this operating state, which can represent a speakerphone feature, it can be assumed that the flip and base assemblies are in the open position (see FIG. 3) and the SCR 100 is either held in the hand of the end user or placed on a table for conferencing purposes.
3. Connecting the tethered portable headset to the headset connector for hands-free communications. In this operating state it can be assumed that the flip and base assemblies are in the closed position (see FIG. 4) with the SCR 100 situated, for instance, on a conventional holster next to the body of an end user.
4. Navigating with the SCR 100 according to navigation information provided by the GPS receiver 110. In this operating state it can be assumed the flip and base assemblies are in the open position (see FIG. 3) with the display 112 actively presenting a map with the location of the SCR 100, and presenting by way of the speaker in the rear assembly audible synthesized voice messages that navigate the user of the SCR 100 to a requested destination.

From each of the foregoing states, a likelihood of electromagnetic interference can be determined from the relative position of the flip and base assemblies carrying the electrical components 102-118 of the SCR 100. For each state, the performance of each antenna 102 can be determined utilizing conventional means for measuring sensitivity performance. These measurements can take place in a laboratory, or alternatively, during operation in the field as historical performance (e.g., signal to noise performance, bit error rate, and like metrics) is gathered by the processor 106 for each antenna 102. This process can provide probability results of the receipt or transmission or wireless signals for each corresponding state. The probability results are in turn stored in the memory of the processor 106 for analysis in step 204 of the method 200.

Referring back to the examples above, in the first operating state it may be determined that the antenna 102B on the base assembly 304 will perform better than the antenna 102A in the flip. This determination may be the result of measuring a poorer performance in the flip antenna 102A when the SCR 100 is being held next to the ear of the end user versus the base antenna 102B, which is held farther away from the body of the end user. In the second operating state it may be determined that when the SCR 100 has the speakerphone feature activated and the flip is in the open position, the flip antenna 102A performs better than the base antenna 102B especially when the base unit is being handheld by a user of the SCR 100. In the third operating state it may be determined that the flip antenna 102A performs better than the base antenna 102B during the hands-free operation where the flip is in the closed position and held away from the user's body. In the operating state where navigation is active and the flip is in the open position it may be determined that the flip antenna 102A performs better than the base antenna 102B.

As mentioned earlier, the foregoing results can be determined experimentally in the laboratory or in real time during the operation of the SCR 100 utilizing conventional metrics for measuring the performance of each antenna 102 in varying operational states. Moreover, the processor 106 can be programmed to apply more complex schemes for selecting an antenna 102 within the scope and spirit of the claims contemplated by the invention described herein. For example, the processor 106 can select one antenna 102 for transmitting while utilizing a different antenna 102 for receiving signals from the communication network (or GPS satellites when using the GPS receiver 110). The statistics gathered in a predetermined manner (such as in a laboratory) or in real time can be compared to a predetermined threshold (as described in step 206 of the method 200) to improve the antenna selection process. This predetermined threshold can be programmed by the end user of the SCR 100 by way of the user interface, pre-programmed in the SCR 100 prior to distribution to an end user, or combinations thereof.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents.

What is claimed is:

1. A device, comprising:
a housing assembly having a plurality of housing portions which can shift relative to each other;
a plurality of antennas distributed among the plurality of housing portions;
a receiver coupled to the plurality of antennas for receiving signals carrying information from a source; and
a processor coupled to the receiver, wherein the processor is programmed to:
sense one or more operating states of the device; and
identify from the one or more operating states an antenna from the plurality of antennas having a probability higher than the other antennas for receiving information from the source.

2. The device of claim 1, further comprising one or more components from a group of components comprising:
a transmitter coupled to the plurality of antennas for transmitting signals carrying information to the source;
one or more sensors for detecting a relative position of the plurality of housing portions;
an audio system; and
an input port, wherein the foregoing components are carried by the housing assembly.

3. The device of claim 2, wherein the one or more operating states are analyzed by the processor from a group of operating states comprising a state of active communications with the source, a state of audio signals played through the audio system corresponding to the active communications, a state of the relative position of the plurality of housing portions, and a state of coupling a portable headset to the input port to redirect audio signals to the portable headset.

4. The device of claim 1, wherein the receiver comprises a GPS (Global Positioning System) receiver and the source comprises GPS satellites.

5. The device of claim 4, wherein a state of processing navigation information from the GPS satellites actively processed by the GPS receiver corresponds to the one or more operating states.

6. The device of claim 1, wherein the processor is further programmed to process signals from the antenna if the probability for receiving information from the source is greater than a predetermined threshold.

7. The device of claim 6, wherein the processor is further programmed to repeat the steps of sensing, identifying, and processing if the probability is lower than the predetermined threshold.

8. The device of claim 2, wherein the processor is further programmed to identify from the one or more operating states an antenna from the plurality of antennas having a probability higher than the other antennas for transmitting signals carrying information to the source.

9. The device of claim 8, wherein the processor is further programmed to activate the transmitter to transmit signals to the antenna if the probability for receiving information at the source is greater than a predetermined threshold.

10. The device of claim 9, wherein the processor is further programmed to repeat the steps sensing, identifying, and activating if the probability is lower than the predetermined threshold.

11. The device of claim 9, wherein the processor is further programmed to identify the antenna according to a likelihood of electromagnetic interference on each of the plurality of antennas from the relative position of the plurality of housing portions carrying one or more electrical components of the device.

12. A selective call radio (SCR), comprising:
a housing assembly having a plurality of housing portions which can shift relative to each other;
a plurality of antennas distributed among the plurality of housing portions;
a transceiver coupled to the plurality of antennas for transmitting and receiving signals carrying information to and from a source; and
a processor coupled to the transceiver, wherein the processor is programmed to:
sense one or more operating states of the SCR;
when a need arises to transmit signals to the source, identify from the one or more operating states an antenna from the plurality of antennas having a probability higher than the other antennas for successfully transmitting signals carrying information to the source; and
when a need arises to receive signals from the source, identify from the one or more operating states an antenna from the plurality of antennas having a probability higher than the other antennas for successfully receiving information from the source.

13. The SCR of claim 12, further comprising one or more components from a group of components comprising:
one or more sensors for detecting a relative position of the plurality of housing portions;
an audio system; and
an input port, wherein each of the foregoing components are carried by the housing assembly.

14. The SCR of claim 13, wherein the one or more operating states are analyzed by the processor from a group of operating states comprising a state of active communications with the communication network, a state of audio signals played through the audio system corresponding to the active communications, a state of the relative position of the plurality of housing portions, and a state of coupling a portable headset to the input port to redirect audio signals to the portable headset.

15. The SCR of claim 12, wherein the processor is further programmed to process signals from the antenna if the probability for transmitting and receiving information to and from the communication network is greater than a predetermined threshold.

16. The SCR of claim 15, wherein the processor is further programmed to repeat the steps of sensing, identifying, and processing if the probability is lower than the predetermined threshold.

17. The SCR of claim 13, wherein the processor is further programmed to identify the antenna according to a likelihood of electromagnetic interference on each of the plurality of antennas from the relative position of the plurality of housing portions carrying one or more electrical components of the SCR.

18. In a selective call radio (SCR) comprising a housing assembly having a plurality of housing portions which can shift relative to each other, a plurality of antennas distributed among the plurality of housing portions, and a transceiver coupled to the plurality of antennas for transmitting and receiving signals carrying information to and from a source, a method comprising the steps of:
sensing one or more operating states of the SCR;
when a need arises to transmit signals to the source, identifying from the one or more operating states an antenna from the plurality of antennas having a probability higher than the other antennas for successfully transmitting signals carrying information to the source; and
when a need arises to receive signals from the source, identifying from the one or more operating states an antenna from the plurality of antennas having a probability higher than the other antennas for successfully receiving information from the source.

19. The method of claim 18, wherein the one or more operating states are analyzed according to a group of operating states comprising a state of active communications with the communication network, a state of audio signals played through the audio system corresponding to the active communications, and a state of the relative position of the plurality of housing portions, and wherein the method further comprises the step of processing signals from the antenna if the probability for transmitting and receiving information to and from the communication network is greater than a predetermined threshold.

20. The method of claim 18, further comprising step of identifying the antenna according to a likelihood of electromagnetic interference on each of the plurality of antennas from the relative position of the plurality of housing portions carrying one or more electrical components of the SCR.
